(19) United States
(12) Patent Application Publication
(10) Pub. No.: US 2023/0278048 A1
(43) Pub. Date: Sep. 7, 2023

(54) AIR-ASSIST SYSTEM FOR A LIQUID PUMP SPRAYER

(71) Applicant: The FountainHead Group, Inc., New York Mills, NY (US)

(72) Inventors: Matthew Merritt, Oneida, NY (US); John Vaughan, Waterville, NY (US); Jeffrey Nicolia, Oneida, NY (US)

(73) Assignee: The FountainHead Group, Inc., New York Mills, NY (US)

(21) Appl. No.: 18/118,041

(22) Filed: Mar. 6, 2023

Related U.S. Application Data
(60) Provisional application No. 63/316,727, filed on Mar. 4, 2022.

(51) Int. Cl. B05B 7/00; B05B 12/32; B05B 7/08; B05B 1/28; B05B 7/14

(52) U.S. Cl. CPC B05B 7/0081; B05B 1/28; B05B 7/0815; B05B 7/1413; B05B 12/32; A01M 1/2033

(57) ABSTRACT

A battery-powered liquid pump air-assist misting sprayer that includes an air outlet ducting system that significantly improves both the ergonomic target focus and the pattern orientation efficiency, especially as when spraying insecticides along bushes and trees.

### CROSS REFERENCE TO RELATED APPLICATION

The present application relates and claims priority to U.S. Provisional Applicaton No. 63/316,727, filed Mar. 4, 2022, the entirety of which is hereby incorporated by reference.

### FIELD OF THE INVENTION

The present disclosure is directed generally to an air-assist system for a battery-powered liquid-pump misting sprayer.

### BACKGROUND

Portable liquid-pump air-assist misting sprayers are widely employed both professionally and around the home to apply such product chemicals as herbicides, insecticides, fertilizers, detergents, disinfectants, and water. These battery-powered sprayers may be hand-carried, worn as a backpack, or wheeled on a cart for transport to the application site.

To assist with the delivery of the liquid mist spray, an air fan is employed in order to assist in propelling the liquid mist such that the application is safe and effective. Especially as in the case of insecticide applications, for example, when spraying along bushes and trees to kill mosquitos, the sprayed product needs to be delivered at a safe distance from the user and, simultaneously, applied with a spray pattern that is effectively oriented and efficiently focused.

A well-understood disadvantage of the conventional portable liquid-pump air-assist misting sprayer is that the outlet spray pattern has a relatively wide horizontal (“left-to-right”) distribution. With respect to the user’s sweeping motion when targeting mosquitos in bushes and trees, this wide horizontal application pattern is wasteful and inefficient.

Another disadvantage to such a conventional misting sprayer is that the air outlet ducting is relatively inefficient, resulting in fan drives that require correspondingly powerful battery systems that are heavy and expensive.

Accordingly, there is a need in the art for a portable air-assist misting sprayer that overcomes the wasteful and inefficient spray pattern delivered by the conventional air-assist misting sprayer.

### SUMMARY

The present disclosure is directed to a battery-powered liquid pump air-assist misting sprayer that includes an air outlet ducting system that significantly improves both the ergonomic target focus and the pattern orientation efficiency.

According to an aspect is a sprayer, comprising a fluid reservoir; a body attached in fluid communication to the fluid reservoir; a powered fan positioned within the body; an air outlet duct formed within the body and having an entrance at one end adjacent the fan and an exit at its opposite end; a fan air inlet formed in the body in proximity to the fan and in fluid communication with the air outlet duct; a liquid outlet nozzle positioned on the body adjacent the exit of the air outlet duct; a duct airfoil positioned at least partially within the air outlet duct and extending at least partially below the outlet nozzle; and a duct air spoiler positioned adjacent to and extending at least partially above the outlet nozzle.

According to an embodiment, the outlet nozzle and outlet duct are canted upward at a predetermined angle relative to the horizontal.

According to an embodiment, the predetermined angle is 15 degrees.

According to an embodiment, the outlet duct is formed in a U-shape.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a perspective view of the disclosed sprayer, in accordance with an embodiment.

FIG. 2 is a detail view of mist nozzle, in accordance with an embodiment.

FIG. 3 is an outlet end-face view of the disclosed sprayer, in accordance with an embodiment.

FIG. 4 is a detail view of mist nozzle outlet, in accordance with an embodiment.

FIG. 5 is a perspective view of the disclosed sprayer, in accordance with an embodiment.

FIG. 6 is a partial section view of the sprayer, in accordance with an embodiment.

FIG. 7 is a schematic representation of the air-flow of the sprayer, in accordance with an embodiment.

FIG. 8 is a bottom plan view of the disclosed sprayer, in accordance with an embodiment.

FIG. 9 is a partial cross-section view of the sprayer taken along section line 9-9 of FIG. 8, in accordance with an embodiment.

### DETAILED DESCRIPTION OF EMBODIMENTS

The present disclosure describes a battery-powered liquid pump air-assist misting sprayer that comprises an air outlet ducting system that significantly improves both the ergonomic target focus and the pattern orientation efficiency, especially as when spraying insecticides along bushes and trees.

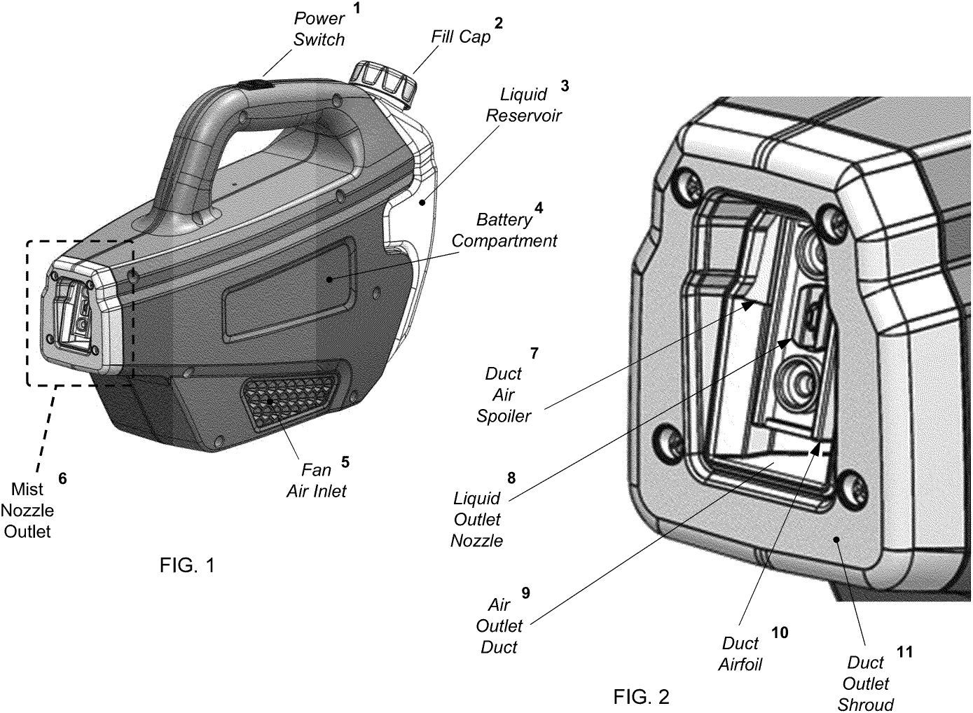

Referring to FIG. 1, in one embodiment, is a sprayer, shown in perspective. Power switch 1 energizes the liquid pump 12 and air-assist fan 13, via batteries in compartment 4. The liquid product is filled into reservoir 3 through cap 2. Air enters/is drawn in the fan at inlet 5. The pressurized liquid spray mist and ducted air is ultimately directed through mist nozzle outlet 6.

FIG. 2 provides a corresponding detail view of mist nozzle outlet 6. Visible here is air outlet duct 9, one of two duct air spoilers 7, a duct airfoil 10, and liquid nozzle outlet 8. Note that both the U-shaped air outlet duct 9 and liquid outlet nozzle 8 are canted upward equally, in this preferred embodiment at a 15-degree angle with respect to the horizontal. Duct outlet shroud 11 provides protection to the internal components and completes the ultimate form of the outlet.

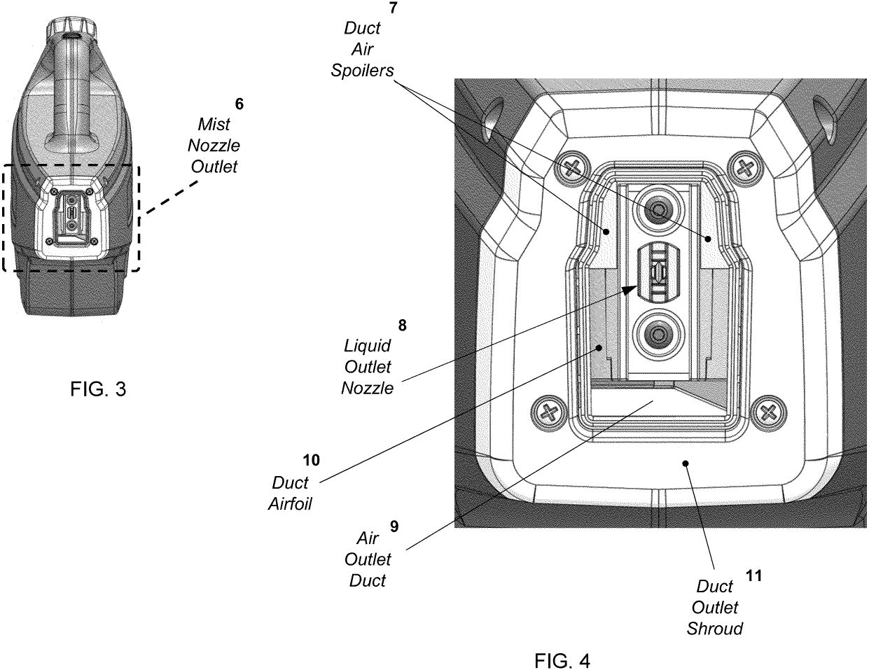

FIG. 3 shows an outlet end-face view of the disclosed sprayer, with mist nozzle outlet 6 identified.

FIG. 4 provides a corresponding detail view of mist nozzle outlet 6, to further illustrate the visible components. As noted previously, duct outlet shroud 11 provides protection to the internal components and completes the ultimate form of the mist nozzle outlet.

At the top of air outlet duct 9 are positioned the duct air spoilers 7 and duct airfoil 10. The liquid outlet nozzle 8 is seen to direct the outlet spray with a vertical orientation, and is positioned for beneficial effect with respect to the outlet air ducting. Note that the cross sectional area of air outlet duct 9 at its exit has a tall and narrow U-shape, such that the overall form of the outlet air has a vertical orientation. Thus, the outlet air advantageously flows below and along the sides of the liquid outlet spray. With novel result, the combination of this exit shape of air outlet duct 9 and the location and orientation of liquid outlet nozzle 8 will be seen to produce an outlet spray pattern that has a focused vertical orientation that is optimal for ergonomic targeting and efficient spray application.

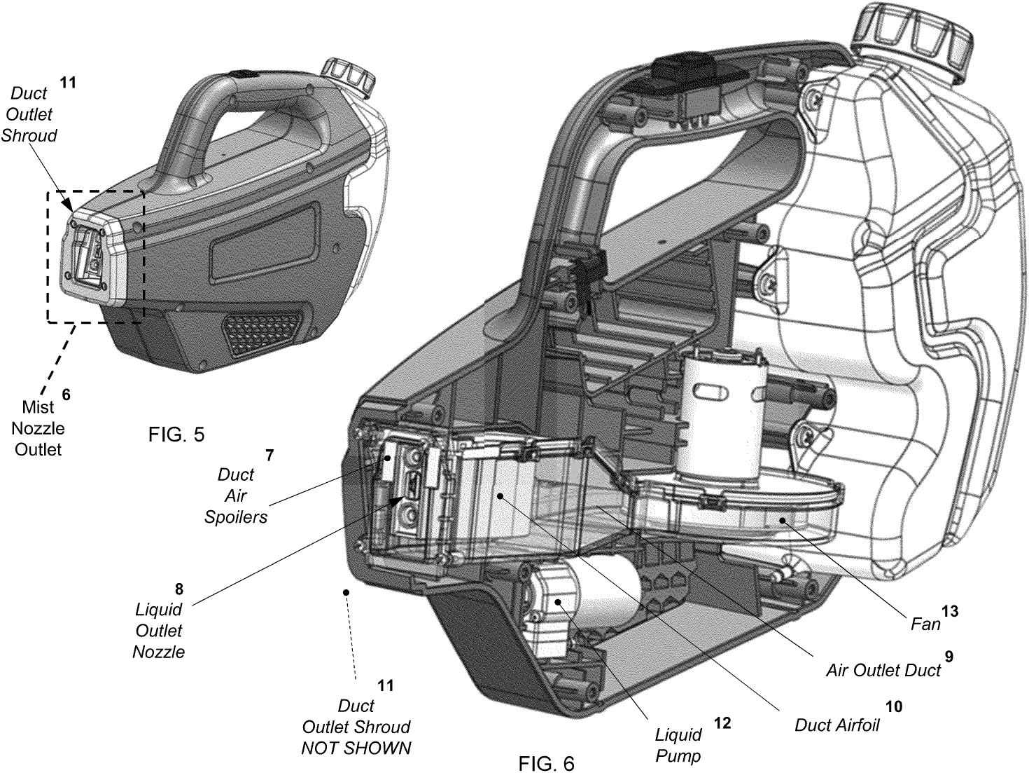

With the disclosed sprayer returned to the perspective view of FIG. 5, a corresponding partial section view of the sprayer is illustrated in FIG. 6. Note that duct outlet shroud 11 is not shown. Here, fan 13 forces air through air outlet duct 9. As will be shown, this outlet air is directed both around the sides of and below duct airfoil 10, with duct air spoilers 7 further guiding a portion of the overall outlet air that exits the ducting of mist outlet nozzle 6. Liquid pump 12 provides the spray pressure for liquid flow through liquid outlet nozzle 8.

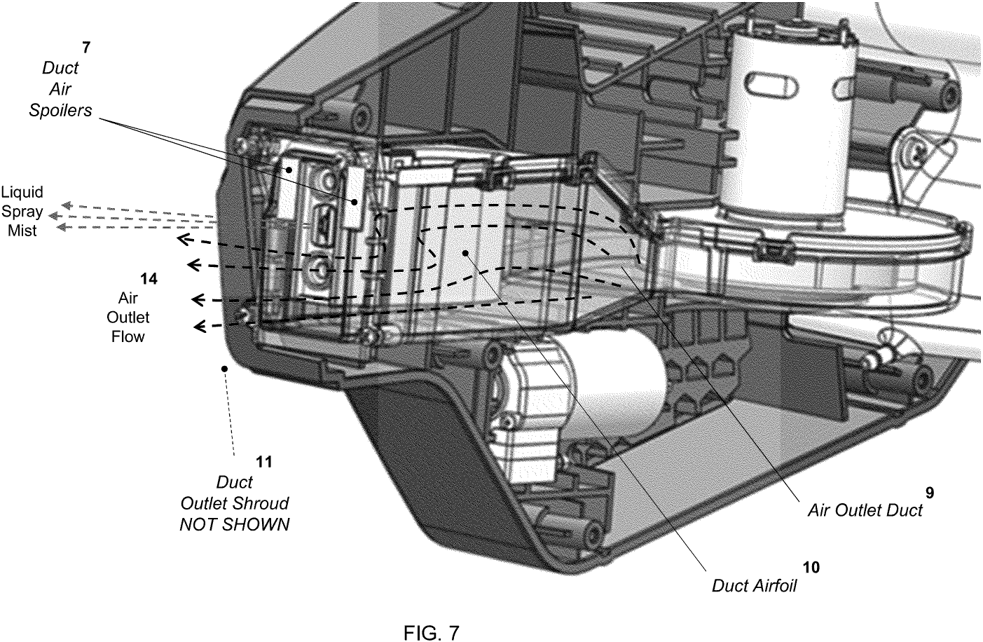

FIG. 7 illustrates the air-assist benefits provided by the combination of duct airfoil 10 and duct air spoilers 7. The forced outlet air, as directed through air outlet duct 9, is guided to duct airfoil 10. This duct airfoil, centrally positioned within the duct and suspended from the top of the duct, is uniquely designed to introduce beneficial laminar air flow to the bulk of the moving air.

As was described in FIG. 4, and now continuing with FIG. 7, the air flow passing along duct airfoil 10 takes on the cross-sectional area form of a tall and narrow U-shape. As the air flow reaches the exit of the duct outlet, novel duct air spoilers 7 then introduce an upset to the top-most portion of flow. The upset provided by the spoilers introduces a beneficial upward boost to the laminar air flow upon exiting the sprayer via duct outlet shroud 11.

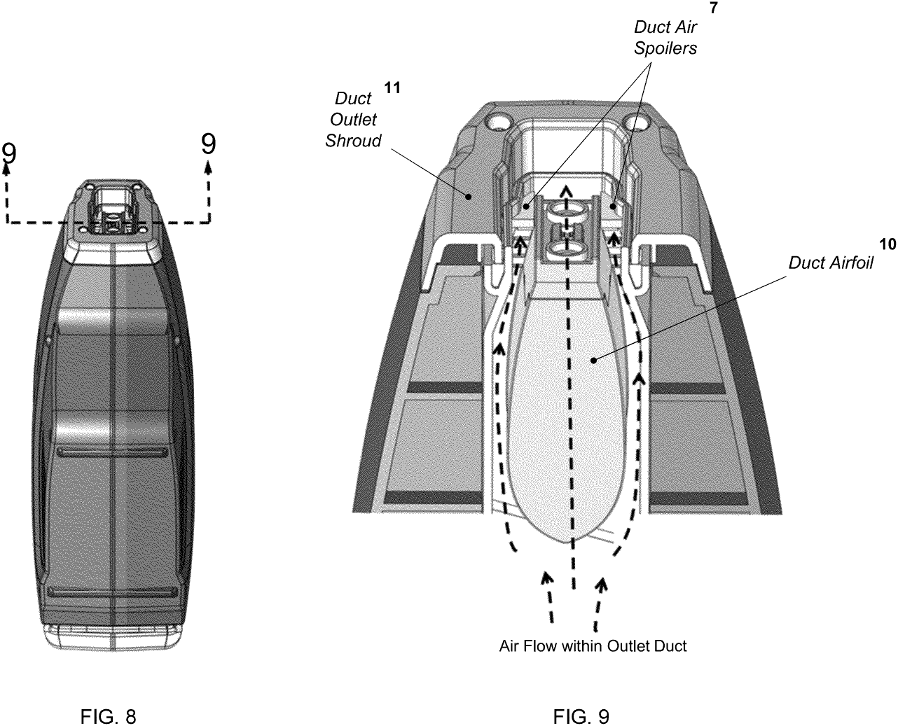

FIG. 8 shows a bottom view of the disclosed sprayer, with a horizontal section indicated.

FIG. 9 shows the resulting partial horizontal section, taken above the bottom of the duct and below the bottom of the duct airfoil 10, so as to describe the internal air flow with additional detail. Note that duct airfoil 10 is not sectioned and therefore seen as complete in this bottom view. The laminar flow, as induced by the air moving along and between the outer shape of the sides of the airfoil and the inner shape of the sides of the outlet duct is revealed. The flow along both sides is shown here, explicitly, only leading up to duct air spoilers 7; as previously described, air flow along the topmost volume of the outlet duct will be purposefully and beneficially upset by the obstruction of the two spoilers positioned at the top of the U-shaped outlet. As previously shown in FIG. 7, this upset air outlet flow 14 continues to exit with beneficial effect to the liquid spray mist.

Continuing with reference to FIG. 9, the air simultaneously moving along the bottom middle of the outlet duct will flow, as shown, with a straight path through the volume of space below the bottom face of duct airfoil 10 so that it exits with a more characteristically turbulent flow. This air flow, which then exits the duct and interacts along the underside of the outlet liquid spray mist, is found to reduce the wasteful fallout of mist particles and improve the propulsion and formation of the liquid mist application pattern.

In operation, this uniquely directed and efficient outlet air flow combines with the liquid mist outlet spray to provide for a propelled, focused, vertically-oriented spray pattern that prevents early mist particle fallout.

The vertical orientation of the mist spray pattern ergonomically aids in targeting the spray, especially when applying mosquito insecticide along and among bushes and trees.

An important additional benefit to this efficient air flow is that a relatively low air flow velocity is required to assist the formation and propulsion of the liquid mist spray pattern. Accordingly, a relatively low-power fan drive may be employed; this results in fewer electric batteries needed. In this way, the disclosed sprayer has less carry weight and lower cost as compared to conventional sprayers.

Another benefit is that the lower air flow velocity for the disclosed sprayer is safer, as the relatively more powerful air flow velocity of the conventional air-assist mist sprayer can often disadvantageously spread farther and dissipate more widely than intended, especially for insecticide application with bushes against building walls.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A sprayer, comprising:
a. a fluid reservoir;
b. a body attached in fluid communication to the fluid reservoir;
c. a powered fan positioned within the body;
d. an air outlet duct formed within the body and having an entrance at one end adjacent the fan and an exit at its opposite end;
e. a fan air inlet formed in the body in proximity to the fan and in fluid communication with the air outlet duct;
f. a liquid outlet nozzle positioned on the body adjacent the exit of the air outlet duct;
g. a duct airfoil positioned at least partially within the air outlet duct and extending at least partially below the outlet nozzle;
h. a duct air spoiler positioned adjacent to and extending at least partially above the outlet nozzle.

2. The sprayer according to claim 1, wherein the outlet nozzle and outlet duct are canted upward at a predetermined angle relative to the horizontal.

3. The sprayer according to claim 2, wherein the predetermined angle is 15 degrees.

4. The sprayer according to claim 1, wherein the outlet duct is formed in a U-shape.
